(19) United States
(12) Patent Application Publication
(10) Pub. No.: US 2024/0225054 A1
(43) Pub. Date: Jul. 11, 2024

(54) FEED SUPPLEMENT BOLUS WITH ACTIVE YEAST

(71) Applicant: TECHMIX, LLC, Stewart, MN (US)

(72) Inventors: Michael L. Nelson, Waconia, MN (US); Marty J. Nelson, Scottsdale, AZ (US); Bradley Welding Kolstad, Lester Prairie, MN (US); Nathan C. Upah, Clutier, IA (US); David J. Muysson, Minnetonka, MN (US); Dennis M. McKillingan, Ames, IA (US); Peter H. Franz, Edina, MN (US)

(21) Appl. No.: 18/536,601

(22) Filed: Dec. 12, 2023

Related U.S. Application Data
(63) Continuation-in-part of application No. 18/080,371, filed on Dec. 13, 2022.
Application No. 18/080,371 is a continuation-in-part of application No. 15/670,285, filed on Aug. 7, 2017, now Pat. No. 11,523,625.

(51) Int. Cl. A23K 50/10; A23K 10/18; A23K 20/158; A23K 20/24; A23K 40/20

(52) U.S. Cl. CPC A23K 50/10; A23K 10/18; A23K 20/158; A23K 20/24; A23K 40/20

(57) ABSTRACT

A ruminant dietary supplement in the form of a pressed shelf-stable solid pill or bolus that effervesces when administered into the reticulum of a ruminant and releases calcium and dried active yeast.

### CROSS-REFERENCE TO RELATED APPLICATIONS

This application is a continuation-in-part of U.S. Ser. No. 18/080,371 filed on Dec. 13, 2022, which is a continuation-in-part of U.S. Ser. No. 15/670,285 filed on Aug. 7, 2017, both of which are hereby incorporated by reference in their entirety.

### FIELD OF THE INVENTION

The present invention relates generally to feed supplement preparations for administration to ruminant animals and, more particularly, to a solid tablet or bolus that provides a release of calcium and dried live active yeast particles into the reticulum of large ruminant animals for the prevention or treatment of hypocalcemia, and to provide a positive increase in additional dietary supplement materials.

### BACKGROUND OF THE INVENTION

Mother domesticated animals, including dairy cows, lactate following the birth of her baby calf (“parturition”). Such lactation involves the secretion of milk by the mother cow from her mammary glands and the resulting amount of time that the mother cow lactates to feed her young calf. The chief purpose of lactation is to provide nutrition and immune protection to the calf after birth. Due to lactation, the mother-calf pair can survive even if food is scarce or too hard for the calf to obtain.

However, the onset of this lactation process follow parturition requires calcium by the mother cow. If this demand for calcium for colostrum and milk production exceeds the mother cow's body's ability to mobilize calcium within the blood stream, then a reduced blood calcium level (“hypocalcemia”) is present. Known more technically as “post parturient hypocalcemia” or “parturient paresis,” and more colloquially as “milk fever,” this disease is of great concern to dairy cow producers and the dairy industry. “Fever” is a misnomer, because the body temperature of the mother cow undergoing a hyprocalcemic blood calcium concentration drop below a critical threshold is not generally elevated. But such hypocalcemia, if left untreated, can rapidly result in a potentially life-threatening state of recumbency.

In the normal calcium regulation process, a decrease in plasma calcium levels causes the parathyroid glands of the mother cow to secrete parathyroid hormone (“PTH”), which regulates the activation of Vitamin D3 in the kidneys. These two compounds act to increase blood calcium levels in increasing adsorption of dietary calcium from the intestine, increasing tubular reabsorption of calcium in the kidneys, and increasing resorption of calcium from bones. It has been found that tissue is less responsive to parathyroid hormone prepartum, compared to postpartum. It is therefore believed that hypocalcemia that causes milk fever is produced by a lower level of responsiveness of the cow's tissues to the circulating parathyroid hormone following the birth of the calf.

The mother cow will typically go through three stages of clinical signs of hypocalcemia. First, the cow is mobile, but shows signs of hypersensitivity and excitability, such as restlessness, tremors, ear twitching, head bobbing, and mild ataxia. If these symptoms are not treated, then the cow usually progresses to the second stage in which she can no longer stand and present in sternal recumbency. Tachycardia, weakened heart contractions, and peripheral pulses ensue. The cow appears dull, has a dry muzzle, cold extremities, and a lower than normal body temperature. Smooth muscle paralysis can cause bloat and the inability to urinate or defecate. Cows often tuck their heads into their flanks. Stage-three hypocalcemia exhibits lateral recumbency, muscle flaccidity, unresponsiveness to stimuli, and loss of consciousness progressing to a coma. The cow's heart rate can approach 120 bpm with peripheral pulses becoming undetectable. If untreated, the cow can die.

Farmers typically try to manage the cow's diet before calving, particularly with regard to mineral and fiber levels, to reduce the occurrence of milk fever after the calves are delivered. But this is not always possible. An injection of synthetic analogue of 25-hydroxycholecalciferol in the days leading up to calving has been tried, although the timing of this pre-treatment makes it difficult to implement.

Once hypocalcemia becomes apparent in the mother cow following delivery of the calves, intravenous calcium injections are often used. However, such calcium injections lead in many cases to “heart blockade” that can be fatal, or transient high calcium levels in the cow that stop the heart. Moreover, some cows can relapse the following day after the injection, or even a third time the day after. Without treatment, between 60-80% of cows afflicted with hypocalcemia usually die.

Solid boluses containing calcium chloride have been produced and administered to animals orally to mother cows after calving. See, e.g., the FRESHCAL calcium bolus product sold by MB Nutritional Sciences of Lubbock, Texas that contains a 50 gram dose of calcium and 70,000 IU of Vitamin D3. Such product is advertises as being administered to help combat subclinical hypocalcemia and immune system disruptions following calving.

U.S. Published Application 2013/0344005 filed by LeJean discloses two bolus tablets that are used in combination to deliver calcium in effervescent form to a cow. The first tablet contains calcium carbonate, calcium formate, and an acid that is administered to the cow just before calving with rapid absorption of the calcium by the cow due to the effervescence. The second tablet is a slow-release tablet containing calcium formate and calcium carbonate with no effervescence. This slower-release source of calcium is administered to the cow at least twelve hours after the first bolus tablet. Note that neither calcium formate, nor calcium carbonate represent an acidogenic source of calcium.

Another acute problem associated with cows is that in the days leading up to parturition, their dry matter intake decreases, in some cases profoundly. As selection for higher-producing genetics for breeding continues to be emphasized by the industry, the severity of this periparturient dry matter intake suppression becomes of greater consequence. Dry matter intake reduction of 20-25% in the first 24-48 hours after calving is common, independent of calcium status. Should the dry matter intake not increase in concert with milk production, then the fresh cow is at an increased risk for hypocalcemia (milk fever), displaced abomasum, ketosis, and poor lactational performance.

Dry matter intake and nutrient absorption following calving are also influenced by the transition of the rumen microflora within the cow to a diet greater in carbohydrate content, specifically rapidly-fermentable starch, and lower in fiber than she was exposed to prepartum. To rapidly foster the growth and prefoliation of starch digesting bacteria in accordance with energetic demands, there is a need for a dietary supplement that acts as food for these bacteria and ultimately enables the cow to maintain a higher level of dry matter feed intake and resulting in more available energy to support lactation in the immediate period after calving.

It is well known that yeasts can be used to break down the starch within agricultural byproducts like flour and grains. Thus, U.S. Pat. No. 3,843,800 issued to Langejan discloses active dried baker's yeasts with higher retained activity levels used to bake bread and other baking products. It causes the bread to rise by converting fermentable sugars present in the dough into carbon dioxide and ethanol. Given the high dry matter content of such active dried yeast, the yeast product is more stable then other forms of yeast like instant yeast prior to its rehydration and therefore is suitable for use in warmer-temperature countries. It also does not need refrigeration. However, live dried active yeast particles cannot be mixed directly into the dry ingredients unlike instant yeast, thereby requiring a separate rehydration step to be conducted first. Saccharomyces cerevisiae is a common yeast variety used in baker's yeasts. It is a common form of brewer's yeast used in the fermentation of urine and beers. See Paul P. Sniegowski, et al. “Saccharomyces Cerevisiae and Saccharomyces Paradoxus Coexist in a Natural Woodland Site in North America and Display Different Levels of Reproductive Isolation from European Conspecifics,” FEMS Yeast Research, vol. 1, pp. 299-306 (2002).

Yeast microorganisms can also be used as feed supplements to break down the starch within forage and grains consumed by the dairy cows and other animals and therefore sitting inside the reticulo-rumen of, e.g., the cow to make the forage and grains easier to digest in order to increase dry matter intake by the cow. Published PCT Application WO 2012/017363 filed by Cherry et al. discloses tablets for delivering probiotic yeast microorganisms or vitamins to ruminant animals via their drinking water. The tablets can contain probiotics along with a citric acid form of an acid constituent and a sodium bicarbonate base constituent pairing that produce effervescence. The tablets are dropped into water to effervesce with the resulting solution added to the drinking water trough used by a group of cows. The probiotic microorganisms float inside the water trough for consumption by the cows and the effervescence may be meant to speed up the absorption of the probiotic by the animal.

Active dried live active yeast particles in the form of feed supplements are also used within the industry for addition to the cow's feed ration. Such dried live active yeast particles may be of the Sacharomyces cerevisiae variety with the yeast and other ingredients contained in the feed supplement granulated to facilitate its admixture by the farmer with the other feed ingredients for the cow's diet. Lallemand S.A. of Toulouse, France is one such manufacturer. Moreover, Lallemand coats some of its dried live active yeast products with, e.g., a 50:50 mixture of stearic acid and palmitic acid to increase the shelf life of the product. See European Patent No. 2,099,898 issued to Degre et al., and Published PCT Application WO 2001/068808 filed by Durand et al., both of which are hereby incorporated by reference in their entirety within this Application.

Abd-Talib et al, “Survival of Encapsulated Probiotics Through Spray Drying and Non-Refrigerated Storage for Animal Feeds Application,” Agricultural Sciences (vol. 4, no. 5B, pp. 78-83) (2013) discloses a research study directed to a process for spray drying probiotics with the resulting product used in animal feeds. He discloses a couple of different experiments conducted under the research study. First, the probiotics were dispersed into coconut oil using a homogenizer at 3000 rpm for 10-15 minutes. Then the coconut oil-probiotic mixture was mixed up with a water-phase mixture using a homogenizer at 3000 rpm for 10 minutes. This formulation was transferred into a petri dish containing agar for each type of probiotic with the number of probiotic colonies grown in the petri dish calculated after 24 hours.

Separately, a Formulation A “encapsulation agent” containing gum Arabic, gelatin, and coconut oil, or a Formulation D “encapsulation agent” containing gelatin, lecithin, and coconut oil, were mixed with the probiotic particles with the resulting admixture passed through a spray dryer at an inlet temperature of 110° C. and an outlet temperature of 70-75° C. to reduce the moisture content of the resulting powder below 4%. These Formulations A and D were determined by Abd-Talib to be the only stable encapsulation agents that were tested. The resulting emulsified, spray-dried probiotic product exhibited a reduction in number of cells from 2.99×10⁹ cfu/ml to 7.4×10⁷ cfu/ml at room temperature after a two-week period. However, it is highly doubtful that a spray drying process is capable of producing the type of uniformly coated product like Applicants' dried active yeast particles that are uniformly coated around their exterior by a hydrophobic fat or fatty acid substance like vegetable wax, preferably Carnauba wax, without resort to spray drying. Instead, Abd-Talib's formulations consist of an admixture of probiotic particles and emulsion molecules next to each other that will exit from the spray dryer nozzle in a similarly discrete arrangement. The resulting powder product is just as likely to have the probiotic particles surrounding molecules of the emulsion as the emulsion molecules to surround the probiotic particles. Indeed, a spray drying process is more likely to remove moisture from a product than to coat it. Thus, it is doubtful that Abd-Talib's products satisfy his own definition of “encapsulation.”

Therefore, the probiotics tested by Abd-Talib do not seem to be coated with the A or D Formulation materials as that term is normally understood, and he appears to use the word “encapsulation” in a more generalized sense to suggest some kind of shelf stability of the probiotic powder product. He does not seem to spray his material around the exterior of the probiotic particles. Moreover, Abd-Talib seems to derive much of the reported shelf stability of his product by means of the moisture reduction of his probiotic product produced by his spray drying process. In any case, the results reported by Abd-Talib suggest that his probiotic particle powder is, in fact, not very protected. Only 19,000,000 cfu/ml of the cells of the probiotic microorganism remained after two weeks out of the 2,990,000,000 cfu/ml starting number. This 2,971,000,000 cfu/ml reduction in number of cells reflects a 99.3% reduction in cell numbers which does not represent much of a protective coating for the probiotics, particularly in light of the mere two-week time period employed in Abd-Talib's experiment.

Within the animal nutrition industry, it is often easier to administer calcium and dried live active yeast particles to cows and other ruminant animals in the form of a bolus or tablet, instead of an injection or liquid supplement. Such bolus contains a premeasured dose of the calcium compound or dried live active yeast particles for producing a specified concentration of the calcium or dried live active yeast particles within the animal's reticule-rumen. The bolus may be conveniently swallowed by the animal without the need for forcing a liquid dose into the animal's mouth, or injecting a dose into the animal's blood stream. However, the process for producing boluses necessarily results in elevated temperatures and pressures during the manufacturing process that can readily reduce the viability of the dried live active yeast particles. Thus, while it would be highly beneficial to the farmer to provide a bolus containing a premeasured dose of a calcium compound like calcium chloride in combination with the dried live active yeast particles that can be readily administered to the mother cow following calving to treat hypocalcemia, or reduce the chances of its onset, it is also necessary to protect the viability of the dried live active yeast particles contained inside the bolus from heat and pressure condition during the bolus manufacturing process. The calcium in the resulting bolus product would directly treat or reduce the incidence of hypocalcemia in the mother cow, while the dried live active yeast particles would break down the starch within the forage sitting in the reticule-rumen of the cow to make the forage easier to digest by the cow to increase her dry matter intake for colostrum and milk production for the new-borne calf.

### SUMMARY OF THE INVENTION

A feed supplement solid bolus for a ruminant animal like a cow for treating hypocalcemia, also known as “milk fever,” is provided by the invention. The feed supplement solid bolus comprises an acidogenic source of supplemental calcium like CaCl₂) in combination with particles of dried live active yeast that are coated with a hydrophobic fat or fatty acid substance that contributes to a reduction in the degradation of cells in the yeast particles and enables them to remain viable when the yeast particles are homogeneously incorporated into the pressed solid bolus. The hydrophobic fat or fatty acid coating material is applied separately to the dried live active yeast particles to surround them. That is, the hydrophobic fat or fatty acid material is not admixed with the dried live active yeast particles and then sprayed together, such as by means of a spray drying process.

The resulting bolus is swallowed whole by, e.g., the mother cow who has recently given birth to a calf. The dried live active yeast particles will break down the starch within forage sitting within the reticulo-rumen of the cow to make the forage easier to digest to increase dry matter intake by the cow, while the acidogenic supplemental calcium is rapidly absorbed in the cow's rumen to treat the hypocalcemia condition. The ability to combine dried live active yeast particles and calcium chloride inside a compressed bolus is surprising in light of the toxic and caustic environment normally produced by calcium chloride, as well as the stresses placed upon the dried active yeast particles during the physical process of producing the compressed bolus.

The dietary feed supplement of the present invention may additionally include an acid constituent like citric acid and a base constituent like calcium carbonate. These acid and base constituents within the solid bolus react with each other in combination with moisture found inside the cow's reticulo-rumen to produce effervescence which is believed to cause the bolus to dissolve faster and disperse the nutrients contained inside the bolus more quickly and evenly through the reticulo-rumen. Thus, the dietary feed supplement of the present invention can incorporate two different mechanisms for rapid absorption of the calcium source within the cow's reticulo-rumen: (1) the acidogenic properties of the specific calcium source selected; and (2) the effervescence produced by the presence of the acid and base constituents inside the supplement pill or bolus.

The dietary feed supplement of the present invention may also contain minerals like magnesium, potassium, and zinc for improving the health of the cow. Electrolytes may also be included.

### DETAILED DESCRIPTION OF THE PREFERRED EMBODIMENTS

The present invention provides a unique formulation for a dietary feed supplement to be administered to a ruminant animal like a mother cow after calving to treat or reduce the incidence of hypocalcemia that delivers an acidogenic source of calcium like calcium chloride (CaCl₂)) in combination with dried live yeast particles having their viability preserved in an anhydrous pressed solid bolus dosage form. The acidogenic calcium enters the cow's blood stream via reticulo-rumen to treat the hypocalcemia, while the dried live active yeast particles facilitate the breakdown of forage in the cow's reticulo-rumen to increase the cow's energy state and increase the dry matter intake.

For purposes of this Application covering the dietary feed supplement product that is administered to a ruminant animal to treat hypocalcemia, or reduce the incidence of hypocalcemia, the term “reticulo-rumen” needs to be clarified. A ruminant animal has four “stomachs,” the first two of which are the reticulum and the rumen. When the bolus is swallowed by the animal, it is highly probable that it will be deposited into the reticulum. As the bolus is dissolved and effervesces if the necessary acid constituent and base constituent are present inside the bolus, the resulting ingredients inside the bolus will be distributed into the reticulum and the rumen. The vast majority of animal feed will reside inside the rumen and this is where the yeast particles contained inside the bolus will act. The animal nutrition and dairy industries uses the term “reticulo-rumen” to describe the reticulum and the rumen in conjunction, because they are not always discrete organs and digestive activities. By contrast, once the digesta leaves the rumen inside the animal, it flows in sequence through the rest of the gastro-intestinal tract. Applicants have incorporated this term “reticulo-rumen” in their claims to reflect the fact that the bolus of the present invention is not guaranteed to wind up inside the animal's reticulum, as opposed to the rumen, as this concept is understood within the industry.

For purposes of the present invention, “ruminant animal” means any hoofed herbivorous grazing or browsing mammal that is able to acquire nutrients from plant-based food by fermenting it in a specialized stomach prior to digestion, principally through microbial actions. The process, which takes place in the front part of the digestive system, and therefore is called foregut fermentation, typically requires the fermented ingesta known as “cud” to be regurgitated and chewed again. The process of rechewing the cud to further break down plant matter and stimulate digestion is called “rumination.” Examples of such ruminant animals include, but are not limited to cows, cattle, goats, sheep, giraffes, deer, gazelles, antelopes, and camels.

As used in this application, “bolus” means any solid pill or tablet containing a premeasured dose of at least one active ingredient like acidogenic calcium or dried live active yeast particles meant to be administered to a ruminant animal like a cow.

While this Application discusses the dietary feed supplement bolus of the present invention for administration to a cow or “mother cow,” this is done for the convenience of the reader by the way of example, for it should be understood that any other ruminant animal may be administered to bolus product.

It has been found that administering the dietary feed supplement containing large amounts of calcium to the cow is more successful if a stable pressed solid bolus is used, so that the animal swallows the bolus whole into the fluid contained in the reticulo-rumen where it dissolves and reacts. Effervescent release of the calcium, assisted by an acid-base pair of ingredients contained in the bolus, has also been found to be very effective for speeding up the calcium intake into the cow's blood stream to threat the hypocalcemia.

The dietary feed supplement of the present invention contains an acidogenic source of calcium. By “acidogenic” is meant “acid forming” or “producing an acid” where the ionic compound such as a salt containing calcium dissociates into Ca²⁺ cations (which constitutes a Lewis acid) and anions like Cl⁻ where a salt like CaCl₂) provides the acidogenic source of calcium. Thus, for purposes of the present invention, any calcium salt compound capable of disassociating into its respective calcium cations and separate anions in the cow's reticulo-rumen may be utilized inside the bolus for purposes of hastening the delivery of the calcium cations into the cow's bloodstream.

Note that calcium carbonate (CaCO₃) that is frequently used in prior art products as the base in an effervescent acid-base pair is not acidogenic. Calcium carbonate is not a salt and represents instead an alkaline source of calcium, which is the opposite of an acid. Calcium carbonate does not dissolve in water, because the enthalpy of hydration is not large enough to overcome lattice energy. For this reason, CaCO₃ simply cannot provide the rapid-absorption form of calcium for the cow's rumen required to treat the hypocalcemia condition.

Therefore, the acidogenic source of calcium for purposes of the dietary feed supplement should comprise a calcium salt compound that includes, but is not limited to, calcium chloride (CaCl₂)) or calcium propionate [Ca(C₂H₅COO)₂]. Calcium chloride is preferred, and should be present in the bolus in an amount of about 30-70% wt, preferably about 50-70% wt. Such CaCl₂ is very acidic and therefore will be rapidly absorbed in less than one hour in the cow's rumen to produce the quickly-available source of calcium required to treat the cow's hypocalcemia condition. By contrast, CaCO₃ is considerably less acidic and will be absorbed inside the intestines of the cow, instead of the cow's rumen. This absorption process for CaCO₃ will typically take 6-8 hours and will not provide the rapidly available source of calcium needed to treat hypocalcemia.

If calcium propionate is used in the bolus as the acidogenic source of calcium, it should be present in the bolus in the amount of about 50-80% wt, preferably about 65-80% wt. One of the benefits of calcium propionate as the source of acidogenic calcium for the bolus for purposes of the present invention is that, while it contains a similar dose of calcium to CaCl₂) for delivery to the cow, it is also less reactive with the dried live active yeast particles contained in the bolus. Hence, calcium propionate should be less harmful to the viability of the dried live active yeast particles during the manufacture of the boluses that would be the case for CaCl₂).

A commercial benefit of using CaCl₂) or calcium proprionate as the acidogenic source of calcium for the dietary feed supplement bolus is that they represent at the present time the only two calcium compounds that are generally regarded as safe (“GRAS”) for ruminant animals. They have been approved for supplements fed to ruminant animals like cows by the American Association of Feed Control Officials (“AAFCO”). But this does not mean that an alternative acidogenic source of calcium salt could not be used for the dietary feed supplement bolus if the manufacturer wanted to go through the process of obtaining approval from AAFCO that it is safe for animal feeds.

The present invention further has successfully added dried stable active yeast to an anhydrous pressed solid bolus dosage form. Thus, the supplement not only provides needed calcium to the ruminant animal, but it also produces a previously undocumented positive increase in dry matter feed intake and milk production. In this manner, the supplement treats the two biggest problems encountered by cows right after calving: low blood calcium and low feed intake that demonstrates direct economic benefit to the farmer from treatment. It is believed that the yeast successfully enhances microbial action stimulating rumen fermentation.

The yeast particles for purposes of the dietary feed supplement bolus of the present invention should be in the form of dried live active yeast particles. This means that, unlike active yeast, they have been dehydrated by pressing and drying the moisture content to make the yeast particles dormant. Such dried live active yeast particles do not need to be refrigerated to maintain their viability, unlike fresh yeast particles. Such dried live active yeast particles contained inside the bolus are then revived from their dormant state to an active state when they are mixed with warm water contained inside the reticulo-rumen of the cow after the bolus is swallowed by the cow. Were fresh yeast to be incorporated instead into the dietary feed supplement bolus of the present invention, then the bolus of the product would exhibit a considerably shorter shelf-life stability for purposes of the yeast component. This would adversely affect degradation of forage materials inside the reticulo-rumen of the cow that is fed the bolus, thereby reducing the energy state of the animal and its dry matter intake. The yeast species must be capable of breaking down the forage materials contained in the cow's reticulo-rumen to help with the cow's digestion, while moderating the rumen pH to a range of about 5.8-6.5.

Such dried live active yeast particles should preferably comprise the Saccharomyces cerevisiae variety of yeast. Such Saccharomyces cerevisiae variety is found in nature as part of the Saccharomyces sense stricto complex. Other varieties include Saccharomyces paradoxus, Sacchaormyces bayanus, Saccharomyces carinocanus, Saccharomyces kudriavzevii, and Saccharomyces mikatae. A number of different species of the S. cerevisiae variety are known and could be used for purposes of the dietary feed supplement bolus. However, the S. cerevisiae species denominated CNCMI-1077 is preferred.

The yeast is preferably in the form of micro-granules of dried live active yeast particles that are coated with a homogeneous hydrophobic substance such as a hydrophobic fat or fatty acid material that stabilizes the dried live active yeast particles against physical and chemical stresses including heat and compression. This is particularly important if CaCl₂) is used as the acidogenic source of calcium inside the bolus product due to the caustic environment within the bolus contributed by the CaCl₂).

Particularly if an acidogenic source of calcium like CaCl₂ is incorporated into the dietary food supplement bolus that normally produces a toxic and caustic environment during the physical process used for producing the bolus, then the dried live active yeast particles should be precoated with a hydrophobic fat or fatty acid material. Such material contributes to a reduction in the degradation of cells in the yeast particles and enables them to remain viable when the yeast particles are homogenously incorporated into the pressed solid bolus.

Such hydrophobic fat or fatty acid material comprises long-chain fatty acids like oleic acid, olenic acid, palmitic acid, stearic acid, linoleic acid, or linolenic acid. More preferably, two or more of those long-chain fatty acids may be used in combination with each other. The admixture of long-chain fatty acids should uniformly coat the exterior of the dried live active yeast particles in order to provide them protection from the toxic and caustic environment produced by the CaCl₂ acidogenic calcium source during the formation of the boluses.

In a preferred embodiment of the invention, the hydrophobic fat or fatty acid protective material surrounding the dried live active yeast particles may be a mixture of stearic acid and palmitic acid, even more preferable a 50:50 mixture of stearic acid and palmitic acid. See European Patent No. 2,099,898 issued to Degre et al.; and PCT Published Application WO 2001/068808 filed by Durand et al, both of which are incorporated by reference in their entirety by this Application. Lallemand S.A. of Toulouse, France commercializes a product comprising dried live active yeast particles that are coated with such a 50:50 mixture of palmitic acid and stearic acid under its Levucell SC® trademark that is suitable for this application.

For purposes of the bolus product of the present invention, coated dried live active yeast particles should comprise about 1-5% wt of the bolus composition, preferably about 2-4% wt.

In another embodiment of the dietary feed supplement bolus of the present invention, an acid-base pair may be added to the bolus composition to produce an effervescent effect when the cow swallows the bolus to deliver it to the reticulo-rumen where it is exposed to liquid contained in the reticulo-rumen. The acid component may comprise an organic or inorganic acid. Such organic acids include citric acid, malic acid, fumaric acid, lactic acid, and adipic acid. Such inorganic acids include sulfuric acid, phosphoric acid, boric acid, and hydrochloric acid. Citric acid is preferred for the acid component.

The base component may comprise calcium carbonate, or else sodium bicarbonate, potassium carbonate, or sodium hydroxide in combination with a smaller amount of the calcium carbonate. Calcium carbonate provides functional Ca⁺² cations to the cow. Note that if Ca⁺² cations are provided to the cow in other ways such as another ingredient contained inside the bolus, or a separate supplement administered to the cow, then a larger amount of the base component could comprise sodium bicarbonate, potassium carbonate, or sodium hydroxide added in combination with the smaller amount of CaCO₃.

If the acid-base pair is added to the composition for the bolus product, then the acid component should comprise about 5-40% wt of the bolus composition, preferably 20-30% wt. The base component should comprise about 5-40% wt of the bolus composition, preferably about 30-40% wt.

In an alternate embodiment of the bolus invention, corn starch, potato starch, amylose, or amylose pectin may be substituted within the bolus composition for the inclusion of any acid-base pair. Instead of effervescence produced inside the cow's reticulo-rumen by the interaction of the acid component and the base component with water or other liquid inside the reticulo-rumen to enhance the intake of calcium from acidogenic calcium into the bloodstream of the cow, the corn starch, potato starch, amylose, or amylose pectin will “explode” when exposed to the liquid contained inside the reticulo-rumen to cause the bolus to break apart to release the calcium into the cow's bloodstream. Such corn starch, potato starch, amylose, or amylose pectin should be present in the bolus composition in the amount of about 5-10% wt, preferably about 6-10% wt.

The dietary feed supplement bolus of the present invention may comprise other components beyond the acidogenic calcium source, dried live active yeast particles (whether coated or not), and acid-base pair. First, a sugar alcohol may be included in the bolus composition to serve as a bypass sugar. Such sugar alcohol will not be available in the rumen of the cow. But it will be absorbed as glucose inside the small intestine of the cow. The sugar will then enter the bloodstream of the cow to provide needed energy for the cow.

Sugar alcohols that are suitable as the bypass sugar component for the bolus comprise sorbitol, maltitol, xylitol, lactitol, erythritol, mannitol, isomalt or combinations thereof. The sugar alcohol may also comprise hydrogenated starch hydrolysates (“HSH”). Once wetted inside the reticulo-rumen, the HSH starch will disaggregate to also speed up absorption of the calcium from the acidogenic calcium source to the cow's bloodstream in lieu of the effervescence produced by an acid-base pair in the bolus composition. This will help the cow that is in distress due to hypocalcemia.

Sorbitol comprises the preferred sugar alcohol for the bolus composition. The sugar alcohol component should comprise about 5-25% wt of the bolus composition, preferably about 10-20% wt.

Second, the dietary feed supplement bolus may include a binder like sorbitol or monocrystalline cellulose (“MCC”). The binder facilitates compression of the bolus composition admixture during the bolus manufacturing process. It makes the resulting bolus harder so that it may achieve greater durability and shelf-life stability. Such binder should comprise about 5-20% wt of the bolus composition, preferably about 10-15% wt.

Note that for purposes of the dietary feed supplement bolus invention, sorbitol may contribute dual functionality to the bolus product as both a bypass sugar glucose source and a binder. This is why if sorbitol is used in the bolus composition, it should comprise about 5-25% wt of the bolus composition, preferably about 10-20% wt.

Third, the dietary feed supplement bolus composition may include a lubricant like magnesium stearate, calcium stearate, sodium benzoate, adipic acid, or polyethylene glycol. During the bolus manufacturing process, the bolus composition is pushed under a pressure of about 25-37.5 metric tonnes (27.5-41 tons) through a die to form an extrudate which is then cut into individual boluses. Heat buildup will occur around the die opening. The binder contained inside the bolus composition acts to reduce this heat buildup by facilitating passage of the bolus mixture through the die opening for the extrudate. For purposes of the bolus product of this invention, examples of suitable polyethylene glycols (“PEG”) include PEG-4000, PEG-6000, or PEG 8000.

Magnesium stearate is the preferred lubricant. If magnesium stearate or calcium stearate is used as a binder material, it should comprise about 0.5-2.0% wt of the bolus composition. If sodium benzoate or polyethylene glycol is used as the binder, then it should comprise about 5.0% wt of the bolus composition.

Fourth, the dietary feed supplement bolus composition may include one or more nutritional supplements for promoting the health of the cow. This is particularly beneficial if the cow is suffering from hypocalcemia. Such nutritional supplement components may include:
Potassium chloride (about 2.3-15.0% wt of bolus composition).
Niacin RP (about 1.5-5.0% wt, preferably about 3.0% wt, of the bolus composition).
Magnesium sulfate (about 1.0-5.0% wt, preferably about 2.0-3.0% wt, of the bolus composition).
Vitamin E (about 0-4.0% wt, preferably about 0-1.0% wt, of the bolus composition).
Betaine HCL (about 0.025-5.0% wt, preferably about 0.025-1.0% wt, of the bolus composition).
Zinc sulfate (about 0.02-0.5% wt, preferably about 0.05% wt, of bolus composition).

One successful formula for the dietary feed supplement bolus of the present invention had the following range of ingredients.

### Product Ingredients (wt)

| INGREDIENT | MIN % | MAX % | ABOUT |
|---|---|---|---|
| Calcium Chloride | 30% | 70% | 50-70% |
| Calcium Carbonate | 5% | 40% | 30-40% |
| Sugar Alcohol | 5% | 25% | 10-20% |
| Organic Acid | 20% | 40% | 20-30% |
| Potassium Chloride | 2.3% | 15% | |
| Niacin RP | 1.5% | 5.0% | 3.000% |
| Dried Live Active Yeast | 1.0% | 5.0% | 2-4% |
| Magnesium Sulfate | 1.0% | 5.0% | 2-3% |
| Vitamin E | 0% | 4.0% | 0.050% |
| Betaine HCL | 0.025% | 5.0% | 0.025-1.0% |
| Zinc Sulfate | 0.02% | 0.5% | 0.050% |
| Magnesium Stearate | 0.50% | 2.0% | |

One example of a successful product has about 2-3% wt dried live active yeast particles, about 8% wt calcium carbonate and about 60% wt calcium chloride. The formula may contain varying amounts of dried live active yeast particles between about 1-5% wt with 2%-3% wt being typical.

The process for preparing the dietary feed supplement bolus for treating hypocalcemia of the present invention is generally as follows:
1. Add the dry ingredients of the bolus composition (except the lubricant) together to form a homogenous premix.
2. Add the lubricant to form the premix for the bolus composition admixture.
3. Introduce the bolus composition admixture into the bolus extruder machine to push it under a pressure of about 25-37.5 metric tonnes (27.5-41 tons) and a maximum temperature of about 120° F. at less than 20% relative humidity through the die plate opening to produce an extrudate.
4. Cut the extrudate into individual boluses.
5. Promptly package the boluses to prevent moisture absorption that could adversely affect the shelf-life stability of the bolus product.

A typical bolus of the present invention will contain a dose of about 110 g of the bolus composition.

A cow who has calved may be administered the bolus product via her mouth to treat hypocalcemia. Preferably two boluses should be administered to the cow at one time per day. Repeat as desired for the cow after 12-24 hours.

The above specification provides a complete description of the components and preparation process for the neonatal bovine dietary supplement product of the present invention. Since many embodiments of the invention can be made without departing from the spirit and scope of the invention, the invention resides in the claims herein appended.

What is claimed is:

1. A ruminant dietary supplement in the form of a pressed shelf-stable solid pill or bolus administered into the reticulo-rumen of a ruminant animal, comprising:
(a) at least 30% wt of an acidogenic calcium salt compound capable of disassociating into its respective calcium cations and separate anions in the ruminant animal's reticulo-rumen; and
(b) particles of dried live active yeast precoated with a hydrophobic fat or fatty acid substance with the coating of the hydrophobic fat or fatty acid material separate from the dried live active yeast particles prior to and during the material being sprayed around the exterior of the dried live active yeast particles;
(c) wherein the hydrophobic fat or fatty acid coating contributes to a reduction in the degradation of cells in the yeast particles and enables them to remain viable when the yeast particles are homogeneously incorporated into the pressed solid pill or bolus.

2. The ruminant dietary supplement of claim 1, wherein the dried live active yeast particles comprise the Saccharomyces cerevisiae variety of yeast.

3. The ruminant dietary supplement of claim 2, wherein the S. cerevisiae species is denominated CNCMI-1077.

4. The ruminant dietary supplement of claim 1, wherein the amount of dried live active yeast is about 1-5% wt of the pill or bolus.

5. The ruminant dietary supplement of claim 4, wherein the amount of dried live active yeast is about 2-4% wt of the pill or bolus.

6. The ruminant dietary supplement of claim 1, wherein the hydrophobic fat or fatty acid precoating material comprises long-chain fatty acids like oleic acid, olenic acid, palmitic acid, stearic acid, linoleic acid, or linolenic acid.

7. The ruminant dietary supplement of claim 6, wherein two or more of said long-chain fatty acids may be used in combination with each other in the hydrophobic fat or fatty acid precoating material.

8. The ruminant dietary supplement of claim 7, wherein the hydrophobic fat or fatty acid precoating material comprises a 50:50 mixture of stearic acid and palmitic acid.

9. The ruminant dietary supplement of claim 1, wherein the acidogenic calcium salt compound comprises calcium chloride or calcium propionate [Ca(C₂H₅COO)₂].

10. The ruminant dietary supplement of claim 9, wherein the pressed shelf-stable solid pill or bolus comprises about 30-70% wt calcium chloride or about 50-80% wt calcium propionate.

11. The ruminant dietary supplement of claim 1 further comprising an acid constituent and a base constituent.

12. The ruminant dietary supplement of claim 11, wherein the acid constituent comprises an organic acid such as citric acid, malic acid, fumaric acid, lactic acid, sorbic acid, formic acid, or an inorganic acid such as sulfuric acid, phosphoric acid, boric acid, and hydrochloric acid, or combinations thereof.

13. The ruminant dietary supplement of claim 11, wherein the base constituent comprises calcium carbonate, sodium bicarbonate, potassium carbonate, or sodium hydroxide in combination with a smaller amount of the calcium carbonate.

14. The ruminant dietary supplement of claim 11, wherein the acid component comprises about 20-40% wt of the pressed shelf-stable solid pill or bolus.

15. The ruminant dietary supplement of claim 11, wherein the base component comprises about 5-40% wt of the pressed shelf-stable solid pill or bolus.

16. The ruminant dietary supplement of claim 1 further comprising corn starch, potato starch, amylose, or amylose pectin that will “explode” when the pressed shelf-stable solid pill or bolus swallowed by the ruminant animal is exposed to the liquid contained inside the reticulo-rumen of the animal to cause the pill or bolus to break apart to release the calcium into the animal's bloodstream.

17. The ruminant dietary supplement of claim 1 further comprising a sugar alcohol within the solid pressed pill or bolus to serve as a bypass sugar that will be absorbed as glucose inside the small intestines of the ruminant animal.

18. The ruminant dietary supplement of claim 17, wherein the sugar alcohol comprises sorbitol, maltitol, xylitol, lactitol, erythritol, mannitol, isomalt or combinations thereof, or hydrogenated starch hydrolysates (“HSH”).

19. The ruminant dietary supplement of claim 18, wherein the sugar alcohol comprises sorbitol in the amount of about 5-25% wt of the pressed shelf-stable solid pill or bolus.

20. The ruminant dietary supplement of claim 1 further comprising a binder like sorbitol or monocrystalline cellulose (“MCC”).

21. The ruminant dietary supplement of claim 1 further comprising a lubricant like magnesium stearate, calcium stearate, sodium benzoate, adipic acid, or polyethylene glycol.

22. The ruminant dietary supplement of claim 21, wherein the lubricant comprises magnesium stearate in the amount of about 0.5-2.0% wt of the pressed shelf-stable solid pill or bolus.

23. The ruminant dietary supplement of claim 1 further comprising one or more minerals within the solid pressed pill or bolus.

24. The ruminant dietary supplement of claim 23, wherein the one or more minerals comprise magnesium, potassium, zinc, or combinations thereof.

25. A ruminant dietary supplement in the form of a pressed shelf-stable solid pill or bolus administered into the reticulo-rumen of a ruminant animal, comprising about 2-4% wt particles of dried live active yeast, about 8% wt calcium carbonate, an acidogenic source of calcium in the form of about 60% wt calcium chloride, and about 5% wt of an acid constituent for producing effervescence within the reticulo-rumen of the ruminant animal when the solid pill or bolus is swallowed.

26. The ruminant dietary supplement of claim 25 further comprising a coating formed from a hydrophobic fat or fatty acid substance around the particles of dried live active yeast with the coating of the hydrophobic fat or fatty acid material separate from the dried live active yeast particles prior to and during the material being sprayed around the exterior of the dried live active yeast particles, said coating contributing to a reduction in the degradation of the cells in the dried live active yeast particles and enabling them to remain viable when the dried live active yeast particles are homogeneously incorporated into the pressed solid pill or bolus.

27. A process for preparing a ruminant dietary supplement in the form of a pressed shelf-stable solid pill or bolus administered into the reticulo-rumen of a ruminant animal, comprising:
(a) forming a homogenous premix comprising:
(i) at least 30% wt of an acidogenic calcium salt compound capable of disassociating into its respective calcium cations and separate anions in the ruminant animal's reticulo-rumen; and
(ii) about 1-5% wt of dried live active yeast precoated with a hydrophobic fat or fatty acid substance with the coating of the hydrophobic fat or fatty acid material separate from the dried live active yeast particles prior to and during the material being sprayed around the exterior of the dried live active yeast particles;
(b) adding a lubricant to the premix to form an admixture;
(c) introducing the admixture into a bolus extruder machine having a die plate opening at its distal end to push the admixture under a pressure of about 25-37.5 metric tonnes (27.5-41 tons) and a maximum temperature of about 120° F. at less than 20% relative humidity through the die plate opening to produce an extrudate;
(d) Cutting the extrudate into individual boluses;
(e) packaging the boluses to prevent moisture absorption that could adversely affect the shelf-life stability of the bolus product.

28. The process of claim 27 further comprising adding one or more additives to the premix selected from the group consisting of a sugar alcohol, a binder, and a nutritional supplement.

29. The ruminant dietary supplement of claim 1, wherein the ruminant animal comprises a cow, sheep, goat, deer, giraffe, or camel.

30. The ruminant dietary supplement of claim 6, wherein the ruminant animal comprises a cow, sheep, goat, deer, giraffe, or camel.

31. A method of use of a ruminant dietary supplement in the form of a pressed shelf-stable solid pill or bolus administered into the reticulo-rumen of a ruminant animal containing at least 30% wt of an acidogenic calcium salt compound capable of disassociating into its respective calcium cations and separate anions in the ruminant animal's reticulo-rumen, and particles of dried live active yeast precoated with a hydrophobic fat or fatty acid substance with the coating of the hydrophobic fat or fatty acid material separate from the dried live active yeast particles prior to and during the material being sprayed around the exterior of the dried live active yeast particles, said method comprising:
(a) being presented with a mother ruminant animal who has borne a baby animal suffering from hypocalcemia;
(b) administering to the mother ruminant animal a dose of the ruminant dietary supplement comprising the acidogenic calcium salt compound and the particles of dried live active yeast precoated with a hydrophobic fat or fatty acid substance; and;
(c) wherein the wherein the ruminant dietary supplement is swallowed by the mother ruminant animal to pass into the reticulo-rumen of the ruminant animal whereupon the calcium salt compound disassociates into its respective calcium cations and separate anions for purposes of hastening the delivery of the calcium cations into the ruminant animal's bloodstream to treat the hypocalcemia.

32. The method of claim 31, wherein the ruminant dietary supplement dose comprises about two boluses at one time per day with the dosage being repeated as desired for the mother ruminant animal after 12-24 hours.
